(19) United States
(12) Patent Application Publication
(10) Pub. No.: US 2004/0030892 A1
(43) Pub. Date: Feb. 12, 2004

(54) Dynamic identification method without identification code

(76) Inventor: Ci Mengfu, Changsha City (CN)

Correspondence Address: THORPE NORTH & WESTERN, LLP., 8180 SOUTH 700 EAST, SUITE 200, P.O. BOX 1219, SANDY, UT, 84070, US

(21) Appl. No.: 10/380,742

(22) PCT Filed: Sep. 17, 2001
(86) PCT No.: PCT/CN01/01401

(30) Foreign Application Priority Data
Sep. 20, 2000 (CN) 00124551.1

(51) Int. Cl. H04L 9/00

(52) U.S. Cl. 713/168

(57) ABSTRACT

A fully dynamic authentication method without identifier is disclosed. The user's original identification code and authentication code can be encrypted dynamically and transmitted by the user terminal to the server, in order to be decrypted there for identification confirmation. In the authentication method of the invention, the identification code and authentication code are encrypted and decrypted unitedly. The results of each encryption are unique and there is no static identification code or feature to be identified each time the user's identification is authenticated.

This application claims priority from International Application No. PCT/CN01/01401 filed on Sep. 17, 2001 under the provisions of the Patent Cooperation Treaty, which claimed priority to Chinese Application No. 00124551.1 filed Sep. 20, 2000.

### FIELD OF THE INVENTION

The present invention relates to the information security field, more particularly, to a fully dynamic authentication system without an identifier.

### BACKGROUND

The generally accepted method for computer network user authentication includes a static identification code, such as a user name, combined with a static password to confirm connections from a valid user. Since a static identification code and password remain unchanged during transmission from the user's terminal to the server for identity authentication, they may be intercepted and captured by a hacker. This information may then be utilized by the hacker to imitate the authorized user, thus foiling the identity authentication system.

In an attempt to eliminate this defect in static authentication, a method was developed based on the static authentication method that employs a static identification code and a dynamic password. A few products based on this new authentication method have been introduced to the market, such as the Dynamic ID card with two-factor authentication based on a “cryptographic key—time (event)” provided by the RSA Security Incorporation. This system will produce a dynamic password automatically with each authentication. However, a user who uses the dynamic password for authentication will get a dynamic password variation based on a variation rule. In such a system, a hacker may make use of the weakness that the static identification code remains unchanged to follow up and analyze the password variations. Eventually the hacker may be able to crack the variation rule of the dynamic password and, after capturing enough information, mimic the authorized user to raise attacks.

### BRIEF DESCRIPTION OF THE DRAWINGS

FIG. 1 illustrates the flow of the identification authentication method according to an embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The present invention can provide an identification authentication system that a hacker may not trace and analyze.

The present invention provides a fully-dynamic authentication method without the transmission of a static identifier. The user's original identification code and authentication code are encrypted dynamically and transmitted by the user terminal to the server, where they can be decrypted for identification confirmation.

In the authentication method of the present invention, the identification code and authentication code are encrypted and decrypted unitedly. The results of each encryption are unique and a static identification code or feature cannot be identified each time the user's identification is authenticated. Therefore, the hacker cannot trace, record and analyze the user's authentication information. Subsequently, the cracking object of the hacker is changed from the variation rule of a single user to that of all users, which provides a higher level of security.

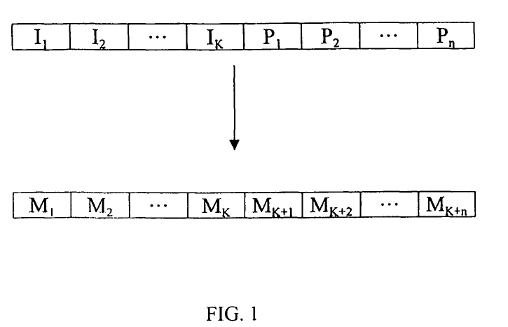

As illustrated in FIG. 1, the original codes are composed of identification codes I₁, I₂, . . . Iₖ and authentication codes P₁, P₂, . . . Pₖ. During identification authentication, the original identification codes and authentication codes are encrypted together, and a dynamic authentication code (M₁, M₂, . . . Mₖ, Mₖ₊₁, Mₖ₊₂, . . . Mₖ₊ₙ) is produced that varies with each authentication. The dynamic identification codes (M₁, M₂, . . . Mₖ, Mₖ₊₁, Mₖ₊₂, . . . Mₖ₊ₙ) are then transmitted to the server where they are decrypted, thus reproducing the original identification code I₁, I₂, . . . Iₖ and the original authentication code P₁, P₂, . . . Pₖ for subsequent identification authentication.

The above encryption may be carried out by encryption software or hardware in the user's computer terminal, and any encryption technology may be used without limiting to the encryption method. For instance, the dynamic encryption result may be achieved by varying the encryption method for each authentication. Alternatively, a constant encryption method may be used with a varying cryptographic key for each authentication. A dynamic encryption method may also be applied to the combined identifier codes and authentication codes. On the other hand, the fully dynamic authentication code without an identifier may be decrypted by the same encryption algorithm system in the server as used in the user's computer terminal, or by using a corresponding public cryptographic key in the server while the encryption on the user side is performed by the private cryptographic key.

An advantage of the present invention is that the identification code and the authentication code are transformed into the fully dynamic identification code which is transmitted to the server for authentication. This means that both the original identification code and the authentication code no longer exist. In addition, authentication methods which use a dynamic identification code without an authentication code are considered to be within the scope of the invention.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

What is claimed is:

1. A method for generating a fully dynamic authentication code comprising the steps of:
providing a user's original identification code and authentication code;
encrypting the user's original identification code and authentication code dynamically in the user terminal to produce a fully dynamic authentication code;
transmitting the fully dynamic authentication code to a server, and the fully dynamic authentication code without identifier will be decrypted in the server for identification confirmation.

2. The method of claim 1 further comprising the step of using the same dynamic encryption algorithm system in both a user's terminal and a server for encryption and decryption.
